(19) United States
(12) Patent Application Publication
(10) Pub. No.: US 2015/0200833 A1
(43) Pub. Date: Jul. 16, 2015

(54) Adaptive Data Migration Using Available System Bandwidth

(71) Applicant: Seagate Technology LLC, Cupertino, CA (US)

(72) Inventors: Craig F. Cutforth, Louisville, CO (US); Caroline W. Arnold, Broomfield, CO (US); Christopher J. DeMattio, Longmont, CO (US)

(73) Assignee: Seagate Technology LLC, Cupertino, CA (US)

(21) Appl. No.: 14/152,398

(22) Filed: Jan. 10, 2014

(51) Int. Cl. H04L 12/26

(52) U.S. Cl. CPC H04L 43/0894

(57) ABSTRACT

Apparatus and method for migrating data within an object storage system using available storage system bandwidth. In accordance with some embodiments, a server communicates with users of the object storage system over a network. A plurality of data storage devices are grouped into zones, with each zone corresponding to a different physical location within the object storage system. A controller direct transfers of data objects between the server and the data storage devices of a selected zone. A rebalancing module directs migration of sets of data objects between zones in relation to an available bandwidth of the server.

### SUMMARY

Various embodiments of the present disclosure are generally directed to an apparatus and method for migrating data within an object storage system using available storage system bandwidth.

In accordance with some embodiments, a server communicates with users of the object storage system over a network. A plurality of data storage devices are grouped into zones, with each zone corresponding to a different physical location within the object storage system. A controller direct transfers of data objects between the server and the data storage devices of a selected zone. A rebalancing module directs migration of sets of data objects between zones in relation to an available bandwidth of the network.

In accordance with other embodiments, an object storage system has a plurality of storage nodes each with a storage controller and an associated group of data storage devices each having associated memory. A server is connected to the storage nodes and configured to direct a transfer of data objects between the storage nodes and at least one user device connected to the distributed object storage system. A rebalancing module is configured to identify an existing system utilization level associated with the transfer of data objects from the server, to determine an overall additional data transfer capability of the distributed object storage system above the existing system utilization level, and to direct a migration of data between the storage nodes during the sample period at a rate nominally equal to the additional data transfer capability.

In accordance with other embodiments, a computer-implemented method includes steps of arranging a plurality of data storage devices into a plurality of zones of an object storage system, each zone corresponding to a different physical location and having an associated controller; using a server to store data objects from users of the object storage system in the respective zones; detecting an available bandwidth of the server; and directing migration of data objects between the zones in relation to the detected available bandwidth.

### BRIEF DESCRIPTION OF THE DRAWINGS

FIG. 1 is a functional representation of a distributed object storage system configured and operated in accordance with various embodiments of the present disclosure.

FIG. 2 illustrates a storage controller and associated storage elements from FIG. 1 in accordance with some embodiments.

FIG. 3 shows a selected storage element from FIG. 2.

FIG. 4 is a functional representation of an exemplary architecture of the distributed object storage system of FIG. 1.

FIG. 5 illustrates a rebalancing module of the system of FIG. 1 in accordance with some embodiments.

FIG. 6 is a graphical representation of system utilization and data migration controlled by the rebalancing module of FIG. 5.

FIG. 7 is an ADAPTIVE REBALANCING routine carried out by the system of FIG. 1 in accordance with some embodiments.

FIG. 8 shows the monitor module of FIG. 5 in accordance with some embodiments.

FIG. 9 is another graphical representation of system utilization and data migration controlled by the rebalancing module of FIG. 5.

FIG. 10 is another graphical representation of system utilization and data migration controlled by the rebalancing module of FIG. 5.

FIG. 11 illustrates another arrangement of the system of FIG. 1 in accordance with some embodiments.

FIG. 12 is a functional block representation of the arrangement of FIG. 11.

### DETAILED DESCRIPTION

The present disclosure generally relates to the migration of data in an object storage system, such as in a cloud computing environment.

Cloud computing generally refers to a network-based distributed data processing environment. Network services such as computational resources, software and/or data are made available to remote users via a wide area network, such as but not limited to the Internet. A cloud computing network can be a public “available-by-subscription” service accessible by substantially any user for a fee, or a private “in-house” service operated by or for the use of one or more dedicated users.

A cloud computing network is generally arranged as a distributed object storage system whereby data objects (e.g., files) from users (“account holders” or simply “accounts”) are replicated and stored in geographically distributed storage locations within the system. The network is often accessed through web-based tools such as web browsers, and provides services to a user as if such services were installed locally on the user's local computer.

Object storage systems (sometimes referred to as “distributed object storage systems”) are often configured to be massively scalable so that new storage nodes, servers, software modules, etc. can be added to the system to expand overall capabilities in a manner transparent to the user. A distributed object storage system can continuously carry out significant amounts of background overhead processing to store, replicate, migrate and rebalance the data objects stored within the system in an effort to ensure the data objects are available to the users at all times.

Various embodiments of the present disclosure are generally directed to advancements in the manner in which an object storage system migrates data objects within the system. As explained below, in some disclosed embodiments a server is adapted to communicate with users of the distributed object storage system over a computer network. A plurality of data storage devices are arranged to provide memory used to store and retrieve data objects of the users of the system. The data storage devices are grouped into a plurality of zones, with each zone corresponding to a different physical location within the distributed object storage system.

A storage controller is associated with each zone of data storage devices. Each storage controller is adapted to direct data transfers between the data storage devices of the associated zone and the proxy server.

During a data migration operation in which data objects are migrated to a new location, a rebalancing module detects the then-existing available bandwidth of the system. The available bandwidth generally represents that portion of the overall capacity of the system that is not currently being used to handle user traffic. The rebalancing module directs the migration of a set of data objects within the system in relation to the detected available bandwidth. In this way, the data objects can be quickly and efficiently migrated without substantively affecting user data access operations with the system.

The available bandwidth can be measured or otherwise determined in a variety of ways. In some cases, traffic levels are measured at the proxy server level. In other cases, an aggregation switch is monitored to determine the available bandwidth. Software routines can be implemented to detect, estimate or otherwise report the respective traffic levels.

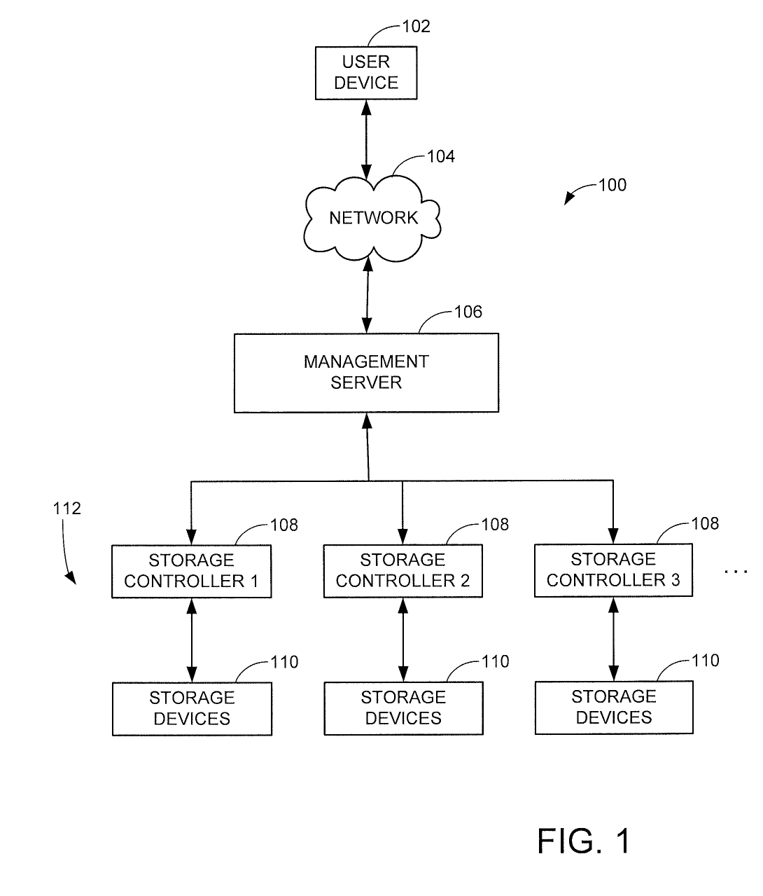

These and various other features of various embodiments disclosed herein can be understood beginning with a review of FIG. 1 which illustrates a distributed object storage system 100. It is contemplated that the system 100 is operated as a subscription-based or private cloud computing network, although such is merely exemplary and not necessarily limiting.

The system 100 is accessed by one or more user devices 102, which may take the form of a network accessible device such as a desktop computer, a terminal, a laptop, a tablet, a smartphone, a game console or other device with network connectivity capabilities. In some cases, each user device 102 accesses the system 100 via a web-based application on the user device that communicates with the system 100 over a network 104. The network 104 may take the form of the Internet or some other computer-based network.

The system 100 includes various elements that are geographically distributed over a large area. These elements include one or more management servers 106 which process communications with the user devices 102 and perform other system functions. A plurality of storage controllers 108 control local groups of storage devices 110 used to store data objects from the user devices 102, and to return the data objects as requested. Each grouping of storage devices 110 and associated controller 108 is characterized as a storage node 112.

While only three storage nodes 112 are illustrated in FIG. 1, it will be appreciated that any number of storage nodes can be provided in, and/or added to, the system. It is contemplated that each storage node constitutes one or more zones. Each zone is a physically separated storage pool configured to be isolated from other zones to the degree that a service interruption event, such as a loss of power, that affects one zone will not likely affect another zone. A zone can take any respective size such as an individual storage device, a group of storage devices, a server cabinet of devices, a group of server cabinets or an entire data center. The system 100 is scalable so that additional servers, controllers and/or storage devices can be added to expand existing zones or add new zones to the system.

Generally, data presented to the system 100 by the users of the system are organized as data objects, each constituting a cohesive associated data set (e.g., a file) having an object identifier (e.g., a “name”). Examples include databases, word processing and other application files, graphics, A/V works, web pages, games, executable programs, etc. Substantially any type of data object can be stored depending on the parametric configuration of the system.

Each data object presented to the system 100 will be subjected to a system replication policy so that multiple copies of the data object are stored in different zones. It is contemplated albeit not required that the system nominally generates and stores three (3) replicas of each data object. This enhances data reliability, but generally increases background overhead processing to maintain the system in an updated state.

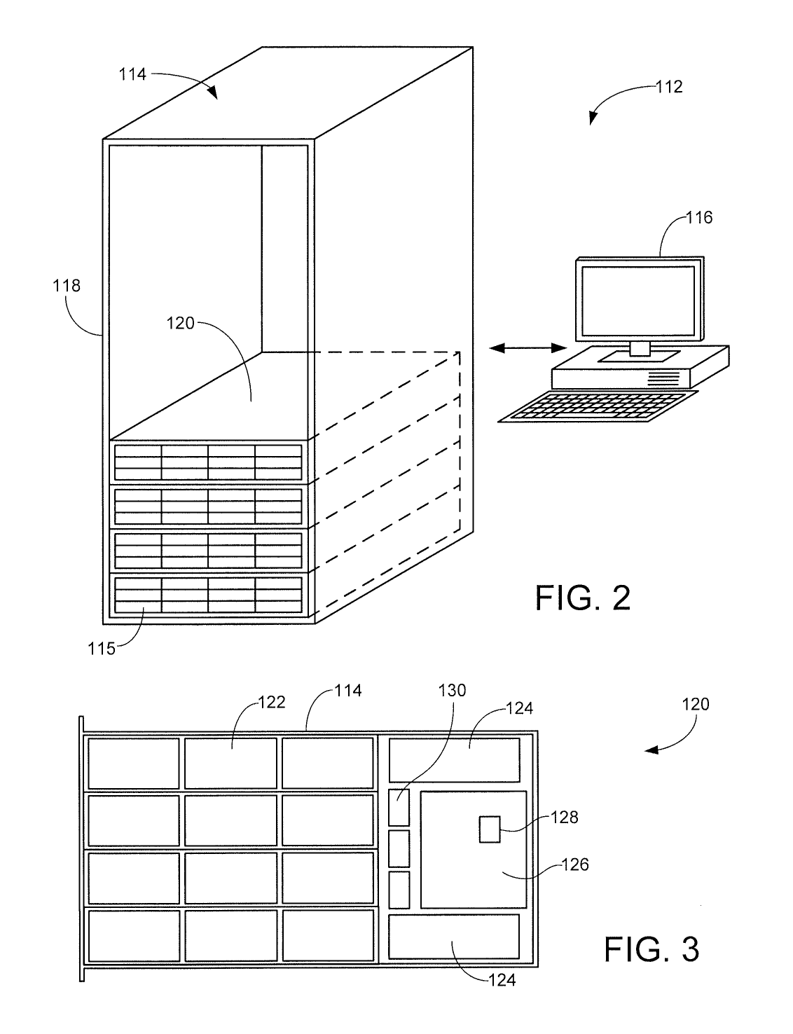

An example hardware architecture for portions of the system 100 is represented in FIG. 2. Other hardware architectures can be used. Each storage node 112 from FIG. 1 includes a storage assembly 114 and a computer 116. The storage assembly 114 includes one or more server cabinets (racks) 118 with a plurality of modular storage enclosures 120.

The storage rack 118 is a 42 U server cabinet with 42 units (U) of storage, with each unit extending about 1.75 inches (in) of height. The width and length dimensions of the cabinet can vary but common values may be on the order of about 24 in.×36 in. Each storage enclosure 120 can have a height that is a multiple of the storage units, such as 2 U (3.5 in.), 3 U (5.25 in.), etc.

In some cases, the functionality of the storage controller 108 can be carried out using the local computer 116. In other cases, the storage controller functionality carried out by processing capabilities of one or more of the storage enclosures 120, and the computer 116 can be eliminated or used for other purposes such as local administrative personnel access. In one embodiment, each storage node 112 from FIG. 1 incorporates four adjacent and interconnected storage assemblies 114 and a single local computer 116 arranged as a dual (failover) redundant storage controller.

An example configuration for a selected storage enclosure 120 is shown in FIG. 3. The enclosure 120 incorporates 36 (3×4×3) data storage devices 122. Other numbers of data storage devices 122 can be incorporated into each enclosure. The data storage devices 122 can take a variety of forms, such as hard disc drives (HDDs), solid-state drives (SSDs), hybrid drives (Solid State Hybrid Drives, SDHDs), etc. Each of the data storage devices 122 includes associated storage media to provide main memory storage capacity for the system 100. Individual data storage capacities may be on the order of about 4 terabytes, TB (4×10¹² bytes), per device, or some other value. Devices of different capacities, and/or different types, can be used in the same node and/or the same enclosure. Each storage node 112 can provide the system 100 with several petabytes, PB (10¹⁵ bytes) of available storage, and the overall storage capability of the system 100 can be several exabytes, EB (10¹⁸ bytes) or more.

In the context of an HDD, the storage media may take the form of one or more axially aligned magnetic recording discs which are rotated at high speed by a spindle motor. Data transducers can be arranged to be controllably moved and hydrodynamically supported adjacent recording surfaces of the storage disc(s). While not limiting, in some embodiments the storage devices 122 are 3½ inch form factor HDDs with nominal dimensions of 5.75 in×4 in×1 in.

In the context of an SSD, the storage media may take the form of one or more flash memory arrays made up of non-volatile flash memory cells. Read/write/erase circuitry can be incorporated into the storage media module to effect data recording, read back and erasure operations. Other forms of solid state memory can be used in the storage media including magnetic random access memory (MRAM), resistive random access memory (RRAM), spin torque transfer random access memory (STRAM), phase change memory (PCM), in-place field programmable gate arrays (FPGAs), electrically erasable electrically programmable read only memories (EEPROMs), etc.

In the context of a hybrid (SDHD) device, the storage media may take multiple forms such as one or more rotatable recording discs and one or more modules of solid state non-volatile memory (e.g., flash memory, etc.). Other configurations for the storage devices 122 are readily contemplated, including other forms of processing devices besides devices primarily characterized as data storage devices, such as computational devices, circuit cards, etc. that at least include computer memory to accept data objects or other system data.

The storage enclosures 120 include various additional components such as power supplies 124, a control board 126 with programmable controller (CPU) 128, fans 130, etc. to enable the data storage devices 122 to store and retrieve user data objects.

An example software architecture of the system 100 is represented by FIG. 3. As before, the software architecture set forth by FIG. 3 is merely illustrative and is not limiting. A proxy server 136 may be formed from the one or more management servers 106 in FIG. 1 and operates to handle overall communications with users 138 of the system 100 via the network 104. It is contemplated that the users 138 communicate with the system 100 via the user devices 102 discussed above in FIG. 1.

The proxy server 136 is connected to a plurality of rings including an account ring 140, a container ring 142 and an object ring 144. Other forms of rings can be incorporated into the system as desired. Generally, each ring is a data structure that maps different types of entities to locations of physical storage. The account ring 140 provides lists of containers, or groups of data objects owned by a particular user (“account”). The container ring 142 provides lists of data objects in each container, and the object ring 144 provides lists of data objects mapped to their particular storage locations.

Each ring 140, 142, 144 has an associated set of services 150, 152, 154 and storage 160, 162, 164. The services and storage enable the respective rings to maintain mapping using zones, devices, partitions and replicas. As mentioned above, a zone is a physical set of storage isolated to some degree from other zones with regard to disruptive events. A given pair of zones can be physically proximate one another, provided that the zones are configured to have different power circuit inputs, uninterruptable power supplies, or other isolation mechanisms to enhance survivability of one zone if a disruptive event affects the other zone. Contrawise, a given pair of zones can be geographically separated so as to be located in different facilities, different cities, different states and/or different countries.

Devices refer to the physical devices in each zone. Partitions represent a complete set of data (e.g., data objects, account databases and container databases) and serve as an intermediate “bucket” that facilitates management locations of the data objects within the cluster. Data may be replicated at the partition level so that each partition is stored three times, one in each zone. The rings further determine which devices are used to service a particular data access operation and which devices should be used in failure handoff scenarios.

In at least some cases, the object services block 154 can include an object server arranged as a relatively straightforward blob server configured to store, retrieve and delete objects stored on local storage devices. The objects are stored as binary files on an associated file system. Metadata may be stored as file extended attributes (xattrs). Each object is stored using a path derived from a hash of the object name and an operational timestamp Last written data always “wins” in a conflict and helps to ensure that the latest object version is returned responsive to a user or system request. Deleted objects are treated as a 0 byte file ending with the extension “.ts” for “tombstone.” This helps to ensure that deleted files are replicated correctly and older versions do not inadvertently reappear in a failure scenario.

The container services block 152 can include a container server which processes listings of objects in respective containers without regard to the physical locations of such objects. The listings may be as SQLite database files or some other form, and are replicated across a cluster similar to the manner in which objects are replicated. The container server may also track statistics with regard t other total number of objects and total storage usage for each container.

The account services block 150 may incorporate an account server that functions in a manner similar to the container server, except that the account server maintains listings of containers rather than objects. To access a particular data object, the account ring 140 is consulted to identify the associated container(s) for the account, the container ring 142 is consulted to identify the associated data object(s), and the object ring 144 is consulted to locate the various copies in physical storage. Commands are thereafter issued to the appropriate storage node 112 (FIGS. 2-3) by the proxy server(s) to retrieve the requested data objects.

Additional services incorporated by or used in conjunction with the rings 140, 142, 144 can include replication services, updating services, ring building services, auditing services and rebalancing services. The replication services attempt to maintain the system in a consistent state by comparing local data with each remote copy to ensure all are at the latest version. Object replication can use a hash list to quickly compare subsections of each partition, and container and account replication can use a combination of hashes and shared high water marks.

The updating services attempt to correct out of sync issues due to failure conditions or periods of high loading when updates cannot be timely serviced. The ring building services build new rings when appropriate, such as when new data and/or new storage capacity are provided to the system. Auditors crawl the local system checking the integrity of objects, containers and accounts. If an error is detected with a particular entity, the entity is quarantined and other services are called to rectify the situation.

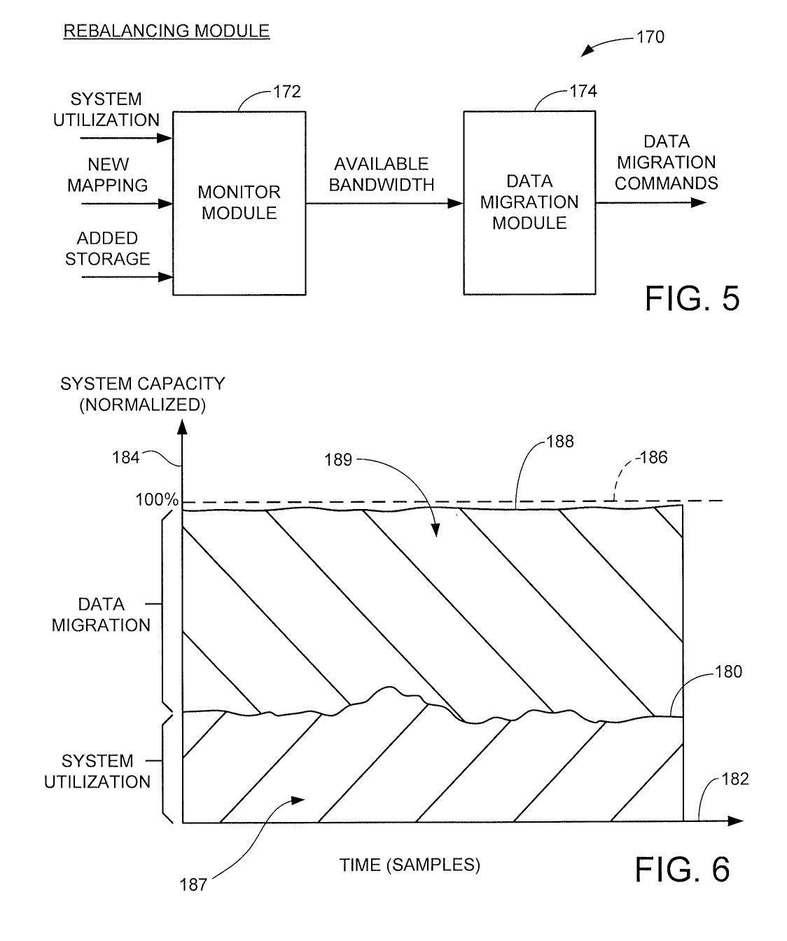

In accordance with various embodiments, rebalancing services are provided by a rebalancing module 170 of the system 100 as represented in FIG. 5. Generally, rebalancing involves data migration from a first storage location to a second storage location to better equalize the distribution of the data objects within the system. The rebalancing module 170 can be realized by any of the logical levels of FIG. 3 as appropriate, such as but not limited to the object services 164 of the object ring 144. Generally, the rebalancing module 170 is operative to rebalance an associated ring (in this case, the object ring) by migrating data objects from one storage location to another to maintain a nominally even amount of data in each zone associated with the ring.

The rebalancing module 170 includes a monitor module 172 and a data migration module 174. The monitor module 172 is operationally responsive to a variety of inputs, including system utilization indications, the deployment of new mapping, the addition of new storage, etc. These and other inputs can signal the monitor module 172 a need to migrate data from one location to another.

Rebalancing may be required, for example, in a storage node 112 to which a new server cabinet 114 (see FIG. 2) is added so that the overall data capacity of the storage node has been increased by some amount (e.g., 25% more available storage, etc.). In another case, an existing data storage device has been replaced and replacement data need to be loaded to the replacement device. In yet another case, system utilization loading has changed and there is a need to relocate large amounts of data throughout the system. In each case, data may be transferred from some physical storage devices 122 to other physical storage devices to balance out the new storage. Such rebalancing will generally involve the transfer of data from one zone to another zone.

Accordingly, at such time that the monitor module 172 determines that a data migration operation is required, the monitor module 172 identifies an available bandwidth of the system 100. The available bandwidth represents the data transfer capacity of the system that is not currently being utilized to service data transfer operations with the users of the system. In some cases, the available bandwidth, B_{AVAIL}, can be determined as follows:

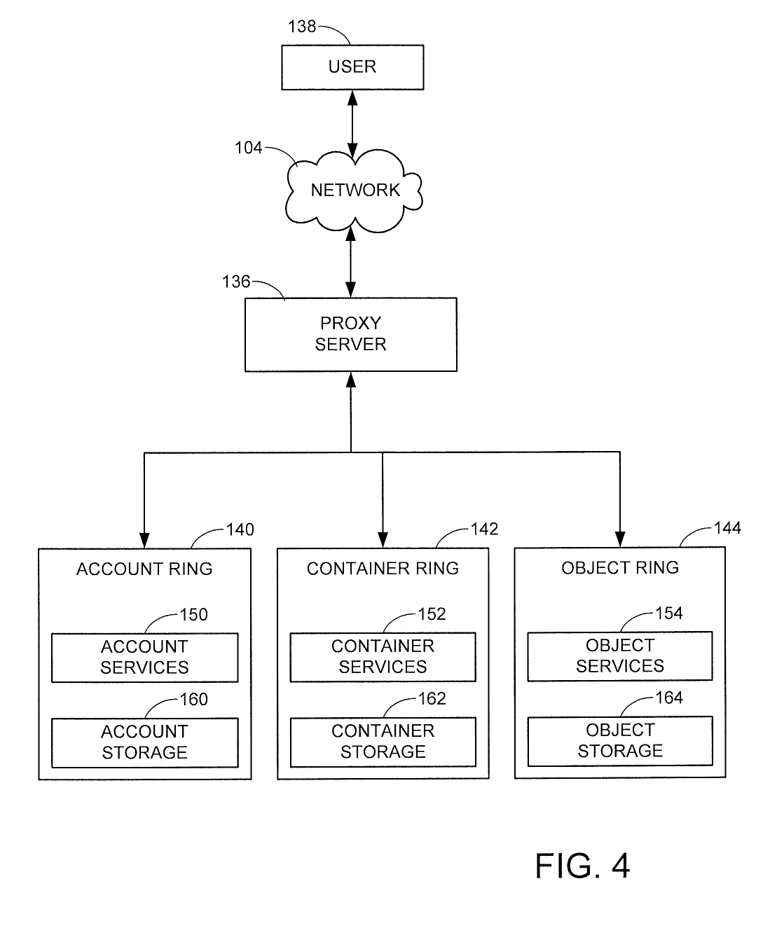

B_{AVAIL}=(C_{TOTAL}−C_{USED})*(1−K) (1)

Where C_{TOTAL} is the total I/O data transfer capacity of the system, C_{USED} is that portion of the total I/O data transfer capacity of the system that is currently being used, and K is a derating (margin) factor. The capacity can be measured in terms of bytes/second transferred between the proxy server 136 and each of the users 138 (see FIG. 4), with C_{TOTAL} representing the peak amount of traffic that could be handled by the system at the proxy server connection to the network 104 under best case conditions, under normal observed peak loading conditions, etc. The capacity can change at different times of day, week, month, etc. Historical data can be used to determine this value.

The C_{USED} value can be obtained by the monitor module 172 directly or indirectly measuring, or estimating, the instantaneous or average traffic volume per unit time at the proxy server 136. Other locations within the system can be measured in lieu of, or in addition to, the proxy server. Generally, however, it is contemplated that the loading at the proxy server 136 will be indicative of overall system loading in a reasonably balanced system.

The derating factor K can be used to provide margin for both changes in peak loading as well as errors in the determined measurements. A suitable value for K may be on the order of 0.02 to 0.05, although other values can be used as desired. It will be appreciated that other formulations and detection methodologies can be used to assess the available bandwidth in the system.

The available bandwidth B_{AVAIL} may be selected for a particular sample time period T_{N}. The sample time period can have any suitable resolution, such as ranging from a few seconds to a few minutes or more depending on system performance. Sample durations can be adaptively adjusted responsive to changes (or lack thereof) in system utilization levels.

The available bandwidth B_{AVAIL} is provided to the data migration module 174, which selects an appropriate volume of data objects to be migrated during the associated sample time period T_{N}. The volume of data migrated is selected to fit within the available bandwidth for the time period. In this way, the migration of the data will generally not interfere with ongoing data access operations with the users of the system. The process is repeated for each successive sample time period T_{N+1}, T_{N+2}, etc. until all of the pending data have been successfully migrated.

In sum, the proxy server 136 has a total data transfer capacity in terms of a total possible number of units of data transferrable per unit of time. The rebalancing module 170 determines the available bandwidth in relation to a difference between the total data transfer capacity and an existing system utilization level of the proxy server, which comprises an actual number of units of user data transferred per unit of time. It will be appreciated that where and how the available bandwidth is measured or otherwise determined will depend in part upon the particular architecture of the system.

FIG. 6 provides a graphical representation of the operation of the rebalancing module 170 of FIG. 5. A system utilization curve 180 is plotted against an elapsed time (samples) x-axis 182 and a normalized system capacity y-axis 184. Broken line 186 represents the normalized (100%) data transfer capacity of the system (e.g., the C_{TOTAL} value from equation (1) above). The cross-hatched area 187 under curve 180 represents the time-varying system utilization by users of the system 100 (e.g., “user traffic”) over a succession of time periods. In other words, the individual values of the curve 180 generally correspond to the C_{USED} value from equation (1).

FIG. 6 further shows a migration curve 188. The cross-hatched area 189 between curves 180 and 188 represents the time-varying volume of data over the associated succession of time periods that is migrated by the data migration module 174 of FIG. 5. The migration curve 188 represents the overall system traffic, that is, the sum of the user traffic and the traffic caused by data migration. The curve 188 lies just below the 100% capacity line 186, and the difference between 186 and 188 generally results from the magnitude of the derating value K as well as data granularity variations in the selection of migrated data objects. It will be appreciated that another factor that can influence the difference between 186 and 188 is inaccurate predictions and/or measurements of actual system utilization.

From a comparison of the relative heights of the respective cross-sectional areas 187, 189 in FIG. 6, it is evident that relatively greater amounts of data are migrated at times of relatively lower system utilization, and relatively smaller amounts of data are migrated at times of relatively higher system utilization. In each case, the total amount of system traffic (curve 188) is nominally maintained below the total capacity of the system (line 186).

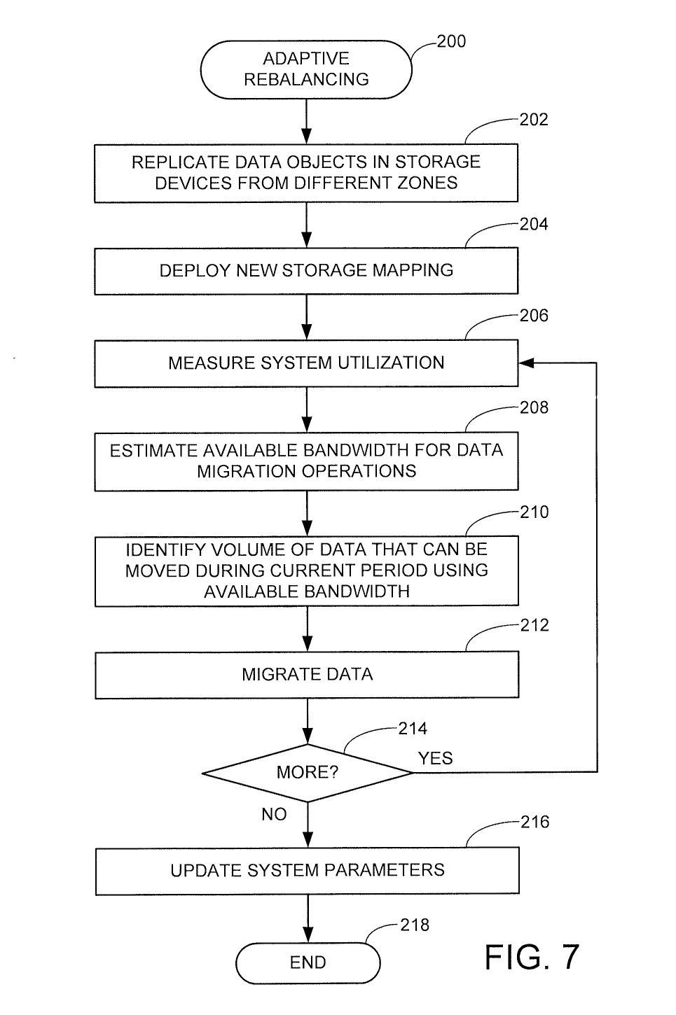

FIG. 7 provides a flow chart for an ADAPTIVE REBALANCING routine 200 generally illustrative of steps carried out by the system 100 in accordance with the foregoing discussion. It will be appreciated that the routine 200 is merely exemplary and is not limiting. The various steps shown in FIG. 7 can be modified, rearranged in a different order, omitted, and other steps can be added as required.

At step 202, data objects supplied by users 138 are replicated in storage devices 122 housed in different zones. Various map structures including account, container and object rings are generated to track the locations of these replicated sets.

New storage mapping is deployed at step 204, such as due to a failure condition, the addition of new memory, or some other event that results in a perceived need to perform a rebalancing operation to migrate data from one zone to another.

The monitor module 172 of FIG. 5 responds to this event by measuring system utilization levels (e.g., the C_{USED} value from equation (1)) at step 206. This information can be obtained in a variety of ways, including via direct or indirect measurement, estimation, reporting from the proxy server 136, etc. An estimated available bandwidth B_{AVAIL} value is next determined at step 208 as the difference between the system utilization level and the total capacity of the system.

At step 210, the data migration module 174 of FIG. 5 uses the estimated available bandwidth value to identify a volume of data objects that can be migrated during the current time period within the available bandwidth value. This may take a number of system parameters into account including measured or estimated internal data path transfer speeds, type of data, estimated or measured data storage device response times, etc. Ultimately, step 210 results in the identification of one or more sets of data objects that should be migrated, as well as the target location(s) to which the objects are to be moved.

The data sets are migrated at step 212, which involves other system services of the architecture to arrange, configure and transfer the data to the new storage location(s). Various other steps such as updated ring structures, tombstoning, etc. may be carried out as well.

Decision step 214 determines whether additional data objects should be migrated, and if so, the routine returns to step 206 for a new measurement of the then-existing system utilization level. In some cases, the migration module 174 may request a command complete status from the invoked resources and compare the actual transfer time to the estimated time to determine whether the data migrations in fact took place in the expected time frame over the last time period. Faster than expected transfers may result in more data object volume being migrated during a subsequent time period, and slower than expected transfers may result in smaller data object volume being migrated during a subsequent time period.

The foregoing processing continues until all data migrations have been completed, at which point any remaining system parameters are updated, step 216, and the process ends at step 218.

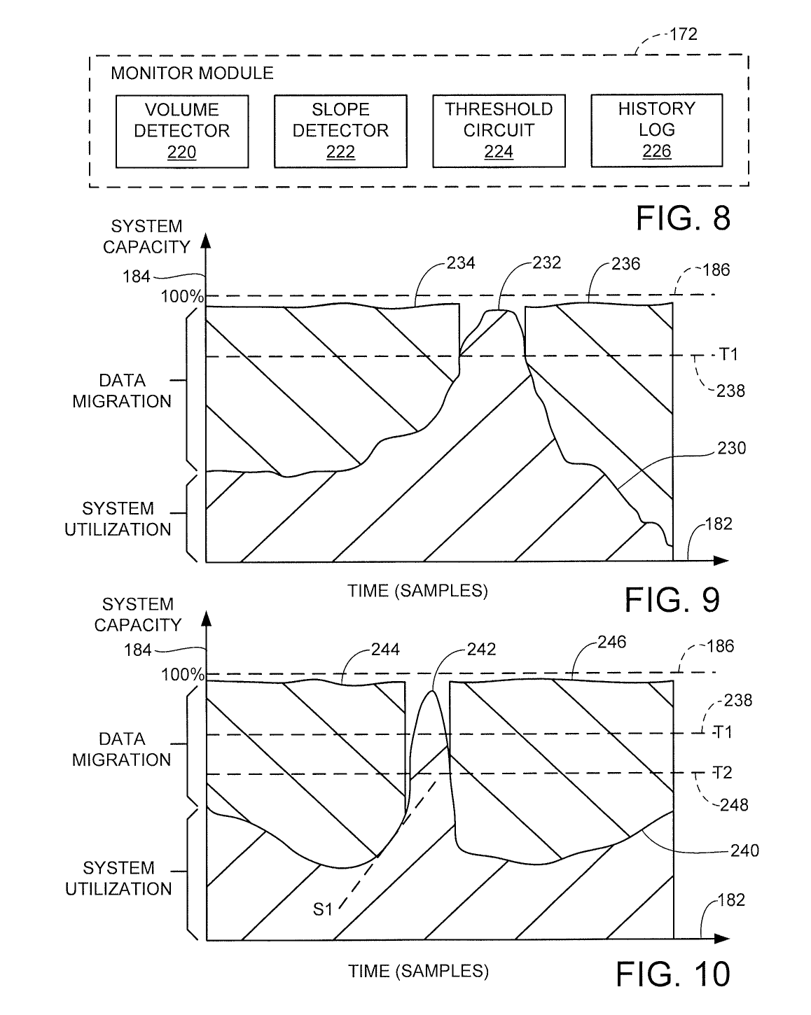

In further embodiments, the monitor module 172 of FIG. 5 may be provisioned with a number of additional capabilities to direct the adaptive migration of data using the routine of FIG. 7. FIG. 8 shows a functional block representation of the monitor module 172 to include a volume detector 220, a slope detector 222, a threshold circuit 224 and a history log 226. These various features can be realized in hardware, software, firmware or a combination thereof, and other features and capabilities can be provided as required.

The volume detector 220 generally operates to detect the volume of data being processed by the proxy server 136 (FIG. 3) over an applicable time period. The slope detector 222 evaluates changes in the system utilization levels from one (or more) sample(s) to the next. The threshold circuit 226 applies one or more thresholds to measured system levels, and the history log 228 provides a history of previous and on-going sample periods.

The operation of these various features can be observed from graphical representations of adaptive data migration operations as set forth in FIGS. 9 and 10. In FIG. 9, a system utilization curve 230 generally corresponds to the curve 180 discussed above in FIG. 6. The cross-hatched area under the curve 230 represents system utilization over the applicable time period.

FIG. 9 shows a substantial increase in system utilization with a peak level occurring at point 232, after which system utilization decreases. It will be appreciated that the data points making up the curve 230 can be obtained from the volume detector 222 of the monitor module 172 in FIG. 8, or via some other mechanism.

Data migration curve segments 234, 236 are located on opposing sides of the peak utilization point 232, and the cross-hatched areas under these respective segments and above line 230 correspond to first and second data migration intervals. A threshold T1 is denoted by broken line 238. This threshold is established and monitored by the threshold circuit 226 of FIG. 8.

From FIG. 9 it can be seen that data migration initially begins (curve 234) while system utilization levels (curve 230) are at moderate levels. System utilization gradually rises and the migration of data continues until the system utilization curve 230 reaches the T1 threshold 238, after which further data migration is temporarily discontinued. Peak utilization is achieved at 232, after which system utilization is reduced. Once the system utilization curve 230 falls below the T1 threshold 238, data migration is resumed under curve segment 236.

In this way, the rebalancing module 170 (FIG. 5) can adaptively detect peak increases in system utilization and temporarily suspend further data migrations until peak utilization levels have passed. The T1 threshold can be any suitable value, such as but not limited to about 80%. Multiple thresholds can be used for different operational conditions, as desired.

FIG. 10 illustrates another system utilization curve 240 with a peak system utilization level at 242. Discontinuous data migration segments are represented at 244, 246. As before, data migration is commenced (under curve 244), temporarily discontinued during peak loading (point 242), and resumed after such peak loading (under curve 246).

In FIG. 10, however, the peak loading is detected using the slope detector 224, which detects an increase in the slope of the utilization curve 240 at slope S1. In this case, it is the change in system utilization rate, rather than the overall system utilization, that triggers the temporary interruption in the data migration operations.

A second threshold T2 is represented by broken line 248, and the data migration operation is resumed (under curve 246) once the system utilization curve falls below this second threshold 248. In some cases, both threshold detection and slope detection mechanisms can be employed to initiate and suspend data migration operations. For example, a relatively low slope may allow data migrations to continue at a relatively higher overall system utilization level, whereas relatively high slopes may signify greater volatility in system utilization and cause the discontinuation (or reduction) of data migrations to account for greater variations. Large volatility in the system utilization rates can cause other adaptive adjustments as well; for example, increases in slope of a system utilization curve (e.g., S1) can cause an increase in the derating factor K (equation (1)) to provide more margin while still allowing data migrations to continue.

Other factors such as historical data (e.g., history log 228), time of day/week/month, previous access (e.g., read/write) patterns, etc. can be included in the adaptive data migration scheme. In this way, data migrations can be adaptively scheduled to maximize data transfers without significantly impacting existing user access to the system.

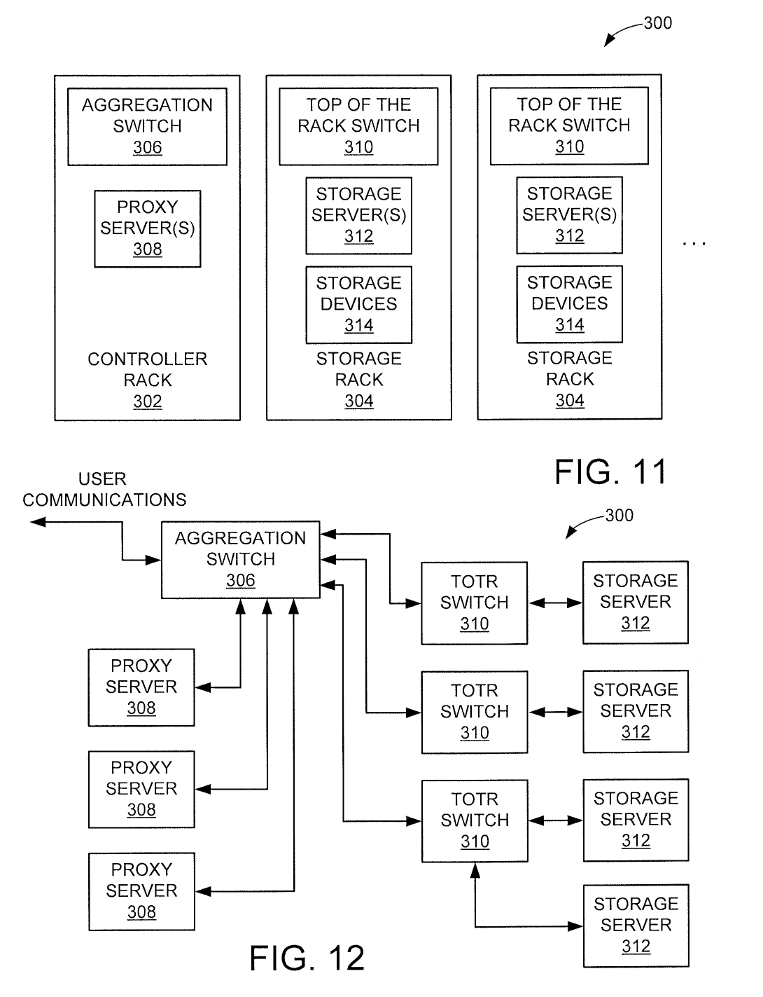

FIGS. 11 and 12 depict another architecture 300 for an object storage system in accordance with the foregoing discussion. It will be appreciated that a variety of architectures can be used, so that FIGS. 11-12 are merely exemplary and not limiting. FIG. 11 shows an arrangement of a controller rack 302 and a number of storage racks 304. The controller rack 302 and the storage racks 304 can each take a form as discussed above in FIGS. 2-3. Thus, the respective racks may be realized as 42 U cabinets, although other configurations can be used.

The controller rack 302 includes an aggregation switch 306 and one or more proxy servers 308. Each storage rack 304 includes a so-called top of the rack (TOTR) switch 310, one or more storage servers 312, and one or more groups of storage devices 314. Other elements can be incorporated into the respective racks, and the configuration can be expanded as required. In one embodiment, each controller rack 302 is associated with three (3) adjacent storage racks.

As depicted in FIG. 12, the aggregation switch comprises a main network switch that provides top level receipt and routing of network traffic, including communications from users of the system. Individual connections (e.g., Ethernet connections, etc.) are provided from the aggregation switch 306 to each of the proxy servers 308. In some cases, multiple proxy servers are provided, with each of the proxy servers concurrently handling multiple different user transactions.

Individual connections are further provided between the aggregation switch 306 and the TOTR switches 310. The TOTR switches provide an access path for the elements in the associated storage rack 304. The storage servers 312 are connected to the TOTR switches 310 in each storage rack 304, and the storage devices 314 (not depicted in FIG. 12) are similarly connected to the storage servers 312.

Different types of data transfers involve different elements within the architecture 300. For example, user access requests are received by the aggregation switch 306 and processed by a selected proxy server 308. The proxy server 308 in turn services the request by passing appropriate access commands through the aggregation switch 306 to the appropriate TOTR switch 310, and from there to the appropriate storage server 312 and storage device 314 (FIG. 11). Retrieved data follows a reverse path back to the proxy server 308, which forwards the retrieved data to the user through the aggregation switch 306.

Internal data migration, balancing and other operations may or may not involve the aggregation switch 306. For example, movement of data from one storage server to another within the same storage rack 304 may be routed through the associated TOTR switch 310. On the other hand, movement of data from one storage rack 304 to another requires passage through the aggregation switch 306.

The available bandwidth can be determined as discussed above by monitoring the system at one or more locations. In some cases, monitoring the movement of user data in service of user communications at the aggregation switch 306 can be used to measure or estimate the available bandwidth. In other cases, each of the proxy servers 308 can be monitored to determine the available bandwidth. Software routines can be executed on the local server(s) and/or switches to measure then-existing levels of user traffic.

Referring again to FIG. 5, it is contemplated that the rebalancing module 170 can be used to control primary data migrations that require system resources that could potentially, or do, directly impact user data access paths; that is, data transfers that consume resources that would otherwise be used for data access operations. Secondary data migrations, such as device-to-device transfers within a given storage enclosure, transfers from one storage cabinet to an adjacent cabinet, etc., may be handled internally by individual storage nodes and may not be included in the volume of data migration managed by the rebalancing module. The rebalancing module 170 may be located at the storage server level.

With reference again to FIG. 1, when multiple storage nodes 112 require data migration operations, the module 170 can allocate different portions of the available bandwidth to each node; for example, a first storage node may be allocated 50% of the available bandwidth, a second storage node may be allocated 30% of the available bandwidth, and a third storage node may be allocated 20% of the available bandwidth. In some cases, each proxy server or other portal/choke point for user traffic in the system may be provisioned with its own rebalancing module 170 that controls the localized data migration for data storage devices associated with that portion of the overall system.

The systems embodied herein are suitable for use in cloud computing environments as well as a variety of other environments. Data storage devices in the form of HDDs, SSDs and SDHDs have been illustrated but are not limiting, as any number of different types of media and operational environments can be adapted to utilize the embodiments disclosed herein

As used herein, the term “available bandwidth” and the like will be understood consistent with the foregoing discussion to describe a data transfer capability/capacity of the system (e.g., network) as the difference between an overall data transfer capacity/capability of the system and that portion of the overall data transfer capacity/capability that is currently utilized to transfer data with users/user devices of the system (e.g., the existing system utilization level). The available bandwidth may or may not be reduced by a small derating margin (e.g., the factor K in equation (1)).

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An object storage system comprising:
a server adapted to communicate with users of the object storage system over a network;
a plurality of data storage devices grouped into zones each corresponding to a different physical location within the object storage system;
a controller adapted to direct transfers of data objects between the server and the data storage devices of a selected zone; and
a rebalancing module adapted to direct migration of sets of data objects between zones in relation to an available bandwidth of the network.

2. The object storage system of claim 1, wherein the rebalancing module is adapted to detect the available bandwidth of the network and to direct migration of the sets of data objects between zones at a rate nominally equal to the detected available bandwidth.

3. The object storage system of claim 1, wherein the proxy server has a total data transfer capacity in terms of a total possible number of units of data transferrable per unit of time, and wherein the rebalancing module detects the available bandwidth in relation to a difference between the total data transfer capacity and an existing system utilization level of the proxy server comprising an actual number of units of user data transferred per unit of time.

4. The object storage system of claim 1, wherein the rebalancing module operates to identify a sample period associated with the available bandwidth and wherein the rebalancing module directs a migration of data objects during the sample period having sufficient volume to nominally equal the available bandwidth.

5. The object storage system of claim 1, wherein the rebalancing module comprises a monitor module which identifies an existing system utilization level of the distributed object storage system in relation to an input from the server.

6. The object storage system of claim 1, wherein, over a succession of consecutive time periods, the rebalancing module measures an existing system utilization level, identifies a different available bandwidth for each of the consecutive time periods in relation to a difference between the existing system utilization level and an overall system data transfer capability, and directs migration operations upon different amounts of data objects for each time period so that the sum, in each time period, of the existing system utilization level and amount of migrated data objects nominally equals the overall system data transfer capability.

7. The object storage system of claim 6, wherein the rebalancing module temporarily suspends further data migration operations responsive to the existing system utilization level for a selected time period reaching a first predetermined threshold.

8. The object storage system of claim 7, wherein the rebalancing module resumes further data migration operations responsive to the existing system utilization level for a subsequent selected time period reaching a second predetermined threshold.

9. The object storage system of claim 8, wherein the first and second predetermined thresholds are equal and constitute a selected percentage of the overall system data transfer capability.

10. The object storage system of claim 6, wherein the rebalancing module temporarily suspends further data migration operations responsive to a rate of change of the system utilization level over a plurality of successive time periods.

11. The object storage system of claim 1, wherein the distributed object storage system is further arranged as a plurality of storage nodes with each storage node comprising a selected storage controller and a subset of the plurality of data storage devices, wherein the rebalancing module allocates a first portion of the available bandwidth to a first storage node of said plurality of storage nodes for the migration of data objects therefrom, and wherein the rebalancing module allocates a second portion of the available bandwidth to a second storage node of said plurality of storage nodes for the migration of data objects therefrom.

12. An object storage system comprising:
a plurality of storage nodes each comprising a storage controller and an associated group of data storage devices each having associated memory;
a server connected to the storage nodes and configured to direct transfer of data objects between the storage nodes and at least one user device connected to the distributed object storage system; and
a rebalancing module configured to identify an existing system utilization level associated with the transfer of data objects from the proxy server, to determine an overall additional data transfer capability of the distributed object storage system above the existing system utilization level, and to direct a migration of data between the storage nodes during the sample period at a rate nominally equal to the additional data transfer capability.

13. The object storage system of claim 12, wherein, over a succession of consecutive time periods, the rebalancing module measures an existing system utilization level, identifies a different available bandwidth for each of the consecutive time periods in relation to a difference between the existing system utilization level and an overall system data transfer capability, and directs migration operations upon different sets of data objects for each time period so that, in each time period, a sum of the existing system utilization level and amount of migrated data objects nominally equals the overall system data transfer capability.

14. The object storage system of claim 13, wherein the rebalancing module temporarily suspends further data migration operations responsive to the existing system utilization level for a selected time period reaching a first predetermined threshold.

15. The object storage system of claim 13, wherein the rebalancing module temporarily suspends further data migration operations responsive to a rate of change of the system utilization level over a plurality of successive time periods.

16. A computer-implemented method comprising:
arranging a plurality of data storage devices into a plurality of zones of an object storage system, each zone corresponding to a different physical location and having an associated controller;
using a server to store data objects from users of the object storage system in the respective zones;
detecting an available bandwidth of the server; and
directing migration of data objects between the zones in relation to the detected available bandwidth.

17. The computer-implemented method of claim 16, wherein the available bandwidth of the proxy server is determined in relation to a difference between a total data transfer capacity associated with the proxy server comprising a total possible number of units of data transferrable per unit time, an existing system utilization level of the server comprising an actual number of units of user data objects transferred per unit of time, and wherein the data objects migrated between the zones comprise a number of units of user data objects transferred per unit of time that nominally matches an overall difference between the total possible number and the actual number.

18. The computer-implemented method of claim 16, further comprising, for each of a succession of consecutive time periods, measuring an existing system utilization level, identifying a different available bandwidth, and directing migration of different total amounts of data objects for each time period so that the sum of the existing system utilization level and the amount of migrated data objects during each time period nominally equals the overall system data transfer capability.

19. The computer-implemented method of claim 18, further comprising temporarily suspending further migration of data objects responsive to the existing system utilization level for a selected time period reaching a first predetermined threshold.

20. The computer-implemented method of claim 18, further comprising temporarily suspending further migration of data objects responsive to a rate of change of the system utilization level exceeding a slope threshold.
